(19) United States
(12) Patent Application Publication
(10) Pub. No.: US 2009/0114366 A1
(43) Pub. Date: May 7, 2009

(54) HEAT EXCHANGER FOR VEHICLE

(75) Inventors: Mitsuru Iwasaki, Saitama-ken (JP); Yuichi Meguriya, Saitama-ken (JP)

Correspondence Address: FOLEY AND LARDNER LLP;SUITE 500, 3000 K STREET NW, WASHINGTON, DC, 20007, US

(73) Assignee: CALSONIC KANSEI CORPORATION

(21) Appl. No.: 12/296,003

(22) PCT Filed: Mar. 23, 2007
(86) PCT No.: PCT/JP2007/055947

§ 371 Date: Dec. 1, 2008

(30) Foreign Application Priority Data
Apr. 4, 2006 (JP) 2006-103527

(51) Int. Cl. B60H 1/00

(52) U.S. Cl. 165/41

(57) ABSTRACT

A heat exchanger for a motor vehicle includes a pair of tanks, a core part and a fan shroud. The tanks are arranged apart from each other in a lateral direction of the motor vehicle. The core part is located between the tanks. The fan shroud is arranged at one of a front side and a rear side of the core part, and the fan shroud is formed with a pair of fan ring portions in which a pair of motor fans is installed, respectively. At least one of an upper end portion and a lower end portion of at least one of the fan ring portions of the fan shroud is protruded from the core part in an upward and downward direction of the core part, and the fan ring portions are arranged at inner sides of the tanks in the lateral direction.

### TECHNICAL FIELD

The present invention relates to a heat exchanger for a motor vehicle, and in particular it relates to a heat exchanger equipped with a pair of fans which is arranged in front of or behind the heat exchanger and is apart from each other in a lateral direction of a motor vehicle.

### BACKGROUND OF THE INVENTION

Japanese Patent Applications Laid-open Publication No. 2005-262979 and No. 2005-233578 disclose conventional heat exchangers that are used for motor vehicles and are equipped with a pair of fans arranged in front of or behind the heat exchangers and being apart from each other in a lateral direction of the motor vehicle.

In such conventional heat exchangers, it is generally known to improve its coolability due to fast flow of a cooling medium in tubes of a core part, by setting an aspect ratio of the core part to be larger so as to form a wide core part, where the aspect ratio is defined by a ratio of a width length and a height length thereof.

In general, the coolability of the heat exchangers is more improved as a rate of opening areas of the fans becomes larger, where the rate of opening areas is defined by an equation of (opening areas of the fans)/(the width length of the core part×the height length).

### DISCLOSURE OF THE INVENTION

### Problem(s) to be Solved by the Invention

However, in the conventional heat exchangers for the motor vehicles, there is a problem in that setting diameters of the fans and their respective fan ring portions of a fan shroud, only allowing for an enlargement in the aspect ratio of the core part and an enlargement in the rate of opening areas of the fans, causes respective end portions, in the lateral direction, of the fans are overlapped with their adjacent tanks, thus generating noise due to collision between the tanks and a part of airflow generated by the fans which are activated.

The present invention is made to solve the above-described problem, and its object is to provide a heat exchanger that can improve its coolability by setting a rate of opening areas of fans to be larger in a wide core part and also can avoid an occurrence of noise.

### Means for Solving the Problems

According to an aspect of the present invention, there is provided a heat exchanger for a motor vehicle including a pair of tanks, a core part and a fan shroud. The pair of tanks is arranged apart from each other in a lateral direction of the motor vehicle. The core part is located between the pair of tanks. The fan shroud is arranged at one of a front side and a rear side of the core part, and the fan shroud is formed with a pair of fan ring portions in which a pair of motor fans is installed, respectively. At least one of an upper end portion and a lower end portion of at least one of the fan ring portions of the fan shroud is protruded from the core part in an upward and downward direction of the core part, and the fan ring portions are arranged at inner sides of the pair of tanks in the lateral direction.

### EFFECT OF THE INVENTION

In the heat exchanger of the present invention, the pair of tanks is arranged apart from each other in the lateral direction of the motor vehicle, the core part is located between the pair of tanks, and the fan shroud is arranged at one of the front side and the rear side of the core part and is formed with the pair of fan ring portions in which the pair of motor fans is installed, respectively. At least one of the upper end portion and the lower end portion of at least one of the fan ring portions of the fan shroud is protruded from the core part in the upward and downward direction of the core part, and the fan ring portions are arranged at the inner sides of the pair of the tanks in the lateral direction. Therefore, the core part can be formed widely, and an opening rate of areas of the fans to an area of the core part can be set to be larger, which can improve a coolability of the heat exchanger and avoid the occurrence of noise due to collision between the tanks and a part of airflow generated by the motor fans which are activated.

### BRIEF DESCRIPTION OF THE DRAWINGS

The objects, features and advantages of the present invention will become apparent as the description proceeds when taken in conjunction with the accompanying drawings, in which:

FIG. 1 is a rear view showing a heat exchanger, of an embodiment according to the present invention, with a fan shroud;

FIG. 2 is a front view showing the heat exchanger of the embodiment;

FIG. 3 is a front view showing the fan shroud shown in FIG. 1; and

FIG. 4 is a characteristic diagram showing a relationship between a rate of opening areas of fans and a heat radiation rate in the embodiment.

### DESCRIPTION OF REFERENCE NUMBERS

P1 inlet port
P2 outlet port
1 heat exchanger for a motor vehicle
2 fan shroud
3, 4 tank
3a, 4a mounting pin
5 core part
6 tube
7 fin
8, 9 reinforcement
10 shroud main body
10a, 10b fan ring portion
11a, 11b fan
11c electric motor
11d fan blade

### BEST MODE FOR CARRYING OUT THE INVENTION

A heat exchanger for a motor vehicle of an embodiment according to the present invention will be described with reference to the accompanying drawings.

The heat exchanger of the embodiment will be described.

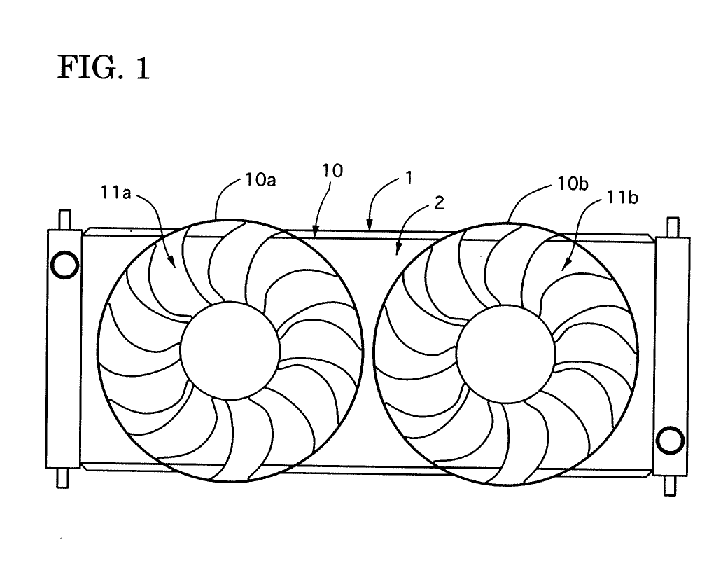

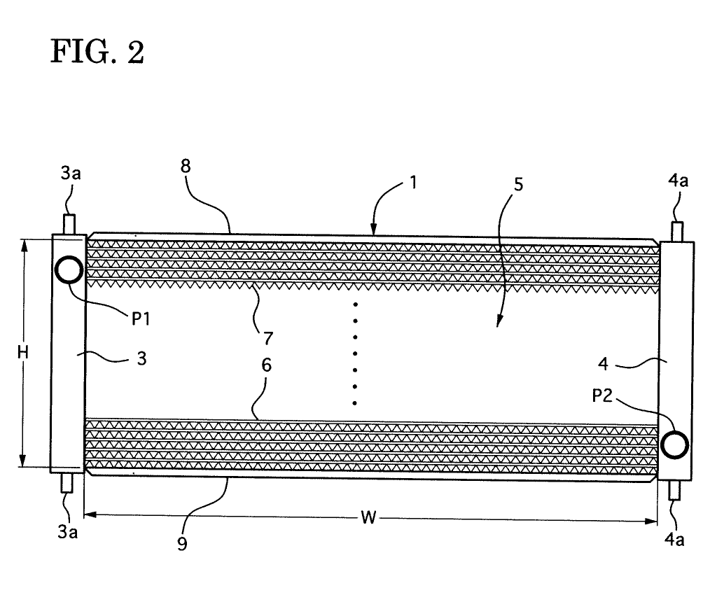

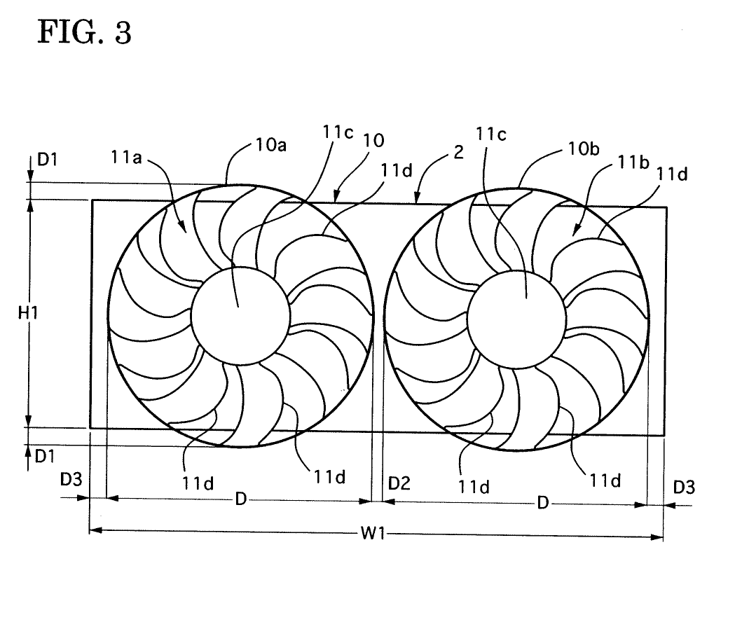

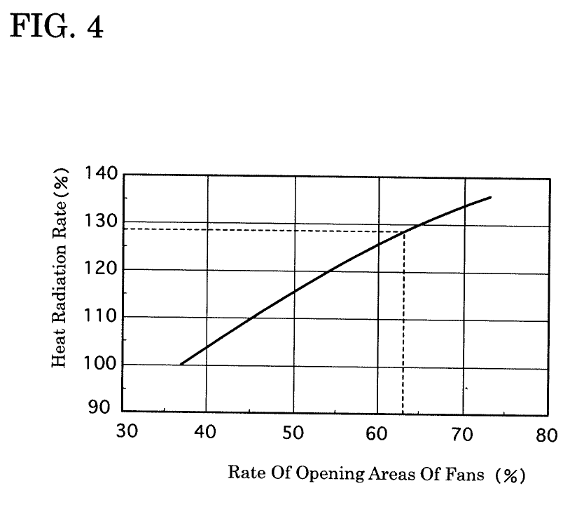

“A longitudinal direction of a motor vehicle” and “a lateral direction of the motor vehicle” are expressed as “a forward-backward direction” and “a right-left direction”, respectively, in this specification. FIG. 1 shows a rear view of the heat exchanger, of the embodiment according to the present invention, with a fan shroud, FIG. 2 shows a front view of the heat exchanger of the embodiment, FIG. 3 shows a front view of the fan shroud shown in FIG. 1, and FIG. 4 shows a characteristic diagram showing a relationship between a rate of opening areas of a pair of fans used in the embodiment.

First an entire construction of the heat exchanger of the embodiment with the fans will be described.

As shown in FIG. 1, in the embodiment, the fan shroud 2 is located behind the heat exchanger 1 that is used for the motor vehicle.

As shown in FIG. 2, the heat exchanger 1 is what is called a parallel flow type radiator which includes a pair of tanks 3 and 4 that are arranged apart from each other, at a right side and at a left side, and a core part 5 arranged between the tanks 3 and 4. All parts of the heat exchanger are made of aluminum.

An inlet port P1 is provided on an upper rear surface of the right tank 3, being formed like a circular cylinder and projecting backward therefrom, to be fluidically communicable with an inner space of the right tank 3, while an outlet port P2 is provided on a lower rear surface of the left tank 4, being formed like a circular cylinder and projecting backward therefrom, to be fluidically communicable with an inner space of the left tank 4.

The core part 5 has a plurality of flat tubes 6 (thirty three tubes in the embodiment) and a plurality of corrugated fins 7, where the both end portions of the tubes 6 are inserted into and fixed to the respective right and left tanks 3 and 4, and each of the corrugated fins 7 is arranged between the adjacent tubes 6.

A pair of reinforcements 8 and 9 connects the right and left tanks 3 and 4 with each other to add to the strength thereof, by both end portions of the reinforcements 8 and 9 being inserted into and fixed to the respective right and left tanks 3 and 4.

On top and bottom portions of the right and left tanks 3 and 4, four mounting pins 3a and 4a are respectively provided for fixing the heat exchanger 1 and the fan shroud 2 on a not-shown radiator core support to form a part of a motor vehicle body.

In the heat exchanger 1 of the embodiment, at least one sides of connecting portions of all the parts thereof are provided with a clad layer, namely a brazing sheet, of brazing filler metal. The parts are temporally assembled with each other and are heat-treated in a not-shown heat furnace, thereby being integrally brazed with and fixed to each other.

The core part 5 of the embodiment is formed as a wide core part, which has the width length W=690 mm, the height length H=277 mm, and accordingly an aspect ratio (the width length W/the height length H)=2.49.

As shown in FIG. 3, the fan shroud 2 has a shroud main body 10 and a left motor fan 11a and a right motor fan 11b, where the shroud main body 10 is formed like a box which opens forward, and the fans 11a and 11b are arranged apart from each other, at a left side and a right side of the shroud main body 10.

The shroud main body 10 is made of plastic material, and is formed as one unit with a left fan ring portion 10a and a right fan ring portion 10b, shaped like a circular cylinder, which are apart from each other in the lateral direction and are projected backward.

Each motor fan 11a, 11b includes an electric motor 11c, and a plurality of fan blades 11d that are driven in a rotational direction of a not-shown rotary shaft of the electric motor 11c. Each fan ring portion 10a, 10b has a not-shown fan stay projecting toward the respective electric motors 11c so that the fan stay fixes and supports the respective electric motors 11c. Incidentally, the motor fans 11a and 11b may be a ring fan that has fan blades end portions of which are connected by a ring portion as one unit.

The fan shroud 2 is formed as a wide fan shroud with the width length W1=690 mm and the height length H1=277 mm, the diameter D of the blades 11d is set to be 320φ, and the left and right fan ring portions 10a and 10b are formed to protrude by D1=approximately 21.5 mm in an upward and downward direction from the shroud main body 10. Clearances between the diameters of the fan blades 11d and the diameters of the left and right fan ring portions 10a and 10b are very small, so that their diameters can be assumed to have approximately the same values.

Thus constructed fan shroud 2 is fixed to the heat radiator 1 by not-shown fasteners in a state where the fan shroud 2 is superimposed onto a rear surface of the heat radiator 1 as shown in FIG. 1. In this state, upper and lower end portions of the fan ring portions 10a and 10b protrude from top and bottom portions of the core part 5, and left and right end portions of the fan ring portions 10a and 10b are arranged in the lateral direction and at inner sides of the respective left and right tanks 3 and 4.

The heat exchanger 1 and the fan shroud 2 are fixed on a not-shown radiator core support, which serves as a part of a motor vehicle body, by using mounting pins 3a and 4a so as to function as a radiator, in which a cooling medium at a high temperature enters the right tank 3 from an engine side through the inlet port P1, then flowing through the tubes 6 into the left tank 4. The cooling medium is cooled due to heat exchange between the cooling medium and an airflow generated when the motor vehicle is running and/or generated by the motor fans 11a and 11b, and then the cooling medium is discharged through the output port P2.

Incidentally, in the conventional heat exchangers, when the diameters of fans 11a and 11b, approximately equal to the diameters of fan ring portions 10a and 10b, are set so that the aspect ratios of the core part 5 becomes to be larger, only allowing for the opening ratios of the fans 11a and 11b, a problem occurs in that lateral-directional end portions of the fans 11a and 11b are overlapped with their adjacent tanks 3 and 4 to generate noise when the fans 11a and 11b are activated.

On the contrary, in the heat exchanger of the embodiment which is provided with the core part 5 with the wide length W=690 mm, the maximum diameter D of the fan blades 11d can be set to be 320φ when allowing for a clearance D2, between the fan ring portions 10a and 10b, that is required for manufacturing the fan shroud 2 and also a margin D3 between the lateral-directional end portions of the fan ring portions 10a and 10b and the respective tanks 3 and 4, where D2=10 mm and D3=20 mm.

As a result, the opening ratio of the motor fans 11a and 11b to the core part 5, namely (the areas of the fans)/(the wide length×the height of the core part), can be secured approximately 64%, thus improving a heat radiation performance (a heat radiation ratio) up to approximately 130%, as shown in FIG. 4, and also avoiding the occurrence of the noise.

Our test shows that a flow speed of the cooling medium reaches up to 2.9 m/s while it flows in the tubes 6 when the engine is running at the maximum rotational speed in a case where the aspect ratio is set to be more than three, so that cavitation might be occurred in an engine pump, although the heat radiation rate of the heat exchanger 1 can be improved according to increase in the opening ratio.

Accordingly, it is preferable to set the aspect ratio to be more than 2.12 and also equal to or smaller than 3. Incidentally, the aspect ratio of 2.12 is obtained in a heat exchanger where the upper and lower end portions of the motor fans 11a and 11b are arranged at the inner sides of the upper and lower end portions of the core part 5. Specifically, in the heat exchanger with the aspect ratio of 2.12, the diameters of the fans are set to be 320φ, the width length of the core part 5 is set to be 690 mm, and the height length thereof is set to be 325 mm.

Therefore, in the heat exchanger 1 of the embodiment, the core part 5 are arranged between the right and left tanks 3 and 4 so that they are separated from each other in the lateral direction, and the pair of the motor fans 11a and 11b are arranged apart from each other in the lateral direction to cool the cooling medium. In the heat exchanger 1, the lateral length of the core part 5 is larger than the sum of the diameters of the pair of motor fans 11a and 11b, each of the height length of the right and left tanks 3 and 4 of the core part 5 is smaller than the diameter of one of the motor fans 11a and 11b, and the pair of the motor fans 11a and 11b are arranged between the pair of tanks 3 and 4.

Next the effects of the heat exchanger of the embodiment will be described. In the heat exchanger 1 of the embodiment, the pair of tanks 3 and 4 is arranged apart from each other in the lateral direction of the motor vehicle, the core part 5 is located between the pair of tanks 3 and 4, and the fan shroud 2 is arranged at one of the front side and the rear side of the core part 5 and is formed with the pair of fan ring portions 10a and 10b in which the pair of fans 11a and 11b is installed, respectively. At least one of the upper end portion and the lower end portion of at least one of the fan ring portions 10a and 10b of the fan shroud 2 is protruded from the core part 5 in the upward and downward direction, and the fan ring portions 10a and 10b are arranged at the inner sides of the tanks 3 and 4 in the lateral direction. Therefore, the core part 5 can be formed widely, and the opening rate of areas of the fans 11a and 11b to the area of the core part 5 can be set to be larger, which can improve the coolability of the heat exchanger 1 and avoid the occurrence of the noise due to collision between the tanks 3 and 4 and a part of airflow generated by the motor fans 11a and 11b which are activated.

As described above, the embodiment has been explained, but the present invention is not limited to the embodiment. Design changes and modifications thereof are contained in the present invention as long as they do not depart from a scope of the present invention.

In the embodiment, the upper and lower end portions of the fan ring portions 10a and 10b are protruded from the core part 5 in the upward and downward direction, but only one of the upper and lower end portions of the fan shroud portions 10a and 10b may be protruded from the core part 5 in the upward and downward direction. In addition, the fan shroud 2 may be arranged in front of the heat exchanger 1 instead of behind it.

In the embodiment, the pair of motor fans 11a and 11b is arranged behind of the heat exchanger 1, but it may be arranged in front of the heat exchanger 1. In this case, the effects can be obtained similarly to those of the embodiment.

### INDUSTRIAL AVAILABILITY

The heat exchanger of the present invention is adaptable for various heat exchangers for vehicles, as long as the heat exchanger has a core part both sides of which are provided with tanks, respectively, and the heat exchanger is also provided with a pair of motor fans in front of or behind the core part.

What is claimed is:

1. A heat exchanger for a motor vehicle comprising:
a pair of tanks arranged apart from each other in a lateral direction of the motor vehicle;
a core part located between the pair of tanks; and
a fan shroud arranged at one of a front side and a rear side of the core part, the fan shroud being formed with a pair of fan ring portions in which a pair of motor fans is installed, respectively, wherein
at least one of an upper end portion and a lower end portion of at least one of the fan ring portions of the fan shroud is protruded from the core part in an upward and downward direction of the core part, and wherein
the fan ring portions are arranged at inner sides of the pair of the tanks in the lateral direction.
